(19) United States
(12) Patent Application Publication
(10) Pub. No.: US 2015/0044427 A1
(43) Pub. Date: Feb. 12, 2015

(54) LABEL

(71) Applicant: 3M INNOVATIVE PROPERTIES COMPANY, ST. Paul, MN (US)

(72) Inventors: Takeshi Yamada, Kanagawa (JP); Shingo Kawasaki, Tokyo (JP)

(21) Appl. No.: 14/380,353

(22) PCT Filed: Feb. 28, 2013
(86) PCT No.: PCT/US2013/028176

§ 371 Date: Aug. 21, 2014

(30) Foreign Application Priority Data
Feb. 28, 2012 (JP) 2012-041576

(51) Int. Cl. G09F 3/02; G09F 3/10

(52) U.S. Cl. CPC G09F 3/02; G09F 3/10; G09F 2003/0257; G09F 2003/0266
USPC 428/174

(57) ABSTRACT

An easily positionable adjustable label at a fixed position on the top of a label receiving surface. The label (10) according to the present invention comprising a sheet having a convex part base material (12), and an adhesion layer (14) provided on the base material inside of the convex part, wherein the convex part bends by applying pressure with a finger of the user, the adhesion layer (14) comes in contacts with the label receiving surface (16), and is pasted on the label receiving surface and before the pasting, the label is slidable on the label receiving surface (16).

### TECHNICAL FIELD

The present invention relates to a label to be stuck on, for example, a note, a notebook or a textbook for the purpose of decoration or emphasizing important points.

### BACKGROUND

Conventionally, a label or seal with various adhesive agents are used for decorating notes neatly or emphasizing points in the textbook that should be learned, and for a schedule listed on a notebook. Normally, a label is placed at a fixed position of a body with adhesive cover such as a page, but matching the position of the label to its fixed place is not always easy. If the place where the label was stuck has shifted from a fixed position, it is necessary to paste it again. However, it is very difficult to change the position of a conventional label once it has been applied.

In contrast, there is a label with a pressure-sensitive adhesive, wherein re-attachment or redetachment is possible, such as the one described in Japanese Laid-open Patent Publication No. 9-134131. Even if the label with pressure-sensitive adhesive which can be re-attached or detached has been used inappropriately, that label can be peeled off and reapplied.

As described above, in the case of a conventional label with an adhesive agent, the initial pasting position is not easy and if the pasting position is mistaken, it is difficult to reapply.

On the other hand, in the case of a label with pressure-sensitive adhesive which can be reattached or detached, it is possible to paste it again, but the work of pasting it again by itself takes time. In addition, similar to the case of a general label, the adjustment of the initial pasting position is not easy. More specifically, when a label is small, that tendency becomes remarkable.

In either case, pasting a label exactly on the desired position of the label receiving surface is not easy.

The need exists for easily adjustable labels.

### SUMMARY OF THE INVENTION

The present invention provides an easily adjustable label at a fixed position on the upper label receiving surface.

According to the first embodiment, in order to achieve the above described problem, the object of the present invention is to provide a label which comprises a sheet having a convex part base material, and an adhesion layer provided on the base material inside of the convex part, wherein the convex part bends upon application of pressure with a finger of the user such that the adhesion layer comes into contact with label receiving surface, and adheres thereto. Before application of full pressure to the convex part, the label is easily slidable on the label receiving surface, thereby facilitating easily locating the label as desired.

According to such a structure, the adhesion layer can be in contact at the label receiving surface since the convex part is transformed as a flat form by pushing the convex part with the user's finger, and through this, a label can be pasted on the label receiving surface.

On the other hand, when the required force is not applied to the convex part, the internal adhesion layer of the convex part does not contact with the label receiving surface, and the label is allowed to slide freely on the label receiving surface even if it has come into contact because the contact area is extremely small.

According to the present invention, the label can be pasted exactly in the desired position because the sliding position can be adjusted on the label receiving surface before pasting it to the label receiving surface. In addition, trouble can also be avoided such as re-pasting due to errors.

### BRIEF DESCRIPTION OF THE DRAWINGS

The invention is further explained with reference to the drawing wherein:

FIG. 1 is a diagram showing the label schematically according to the present invention, (A) is a top view, and (B) is a cross-sectional view along the B-B line of (A);

FIG. 2 is a diagram showing the usage instructions of the label of FIG. 1 with (A) showing the label upon initial placement on the receiving surface, (B) showing adjustment of position in the receiving surface, and (C) showing the label in affixed to the receiving surface;

FIGS. 3(A) and (B) are schematic cross-sectional views of illustrative embodiments of labels of the invention;

FIGS. 4(A) and (B) are schematic cross-sectional views of illustrative embodiments of labels of the invention; and

FIGS. 5(A)-(H) are schematic top views of illustrative embodiments of labels of the invention.

These figures are not to scale and are intended to be merely illustrative and not limiting.

### DETAILED DESCRIPTION OF ILLUSTRATIVE EMBODIMENTS

The label of the embodiment of the present invention comprises a sheet having a convex part base material, and an adhesion layer provided on the base material inside of the convex part, wherein the convex part bends upon application of pressure, e.g., with a finger of the user, the adhesion layer comes in contact with label receiving surface, and is pasted on label receiving surface and before the pasting, the label is slidable on the label receiving surface.

These and other advantages and features of the present invention will become better understood upon consideration of the following detailed description of the invention when considered in connection with the accompanying drawings. Note that, like reference numerals designate like parts throughout the figures thereof, and their descriptions are omitted.

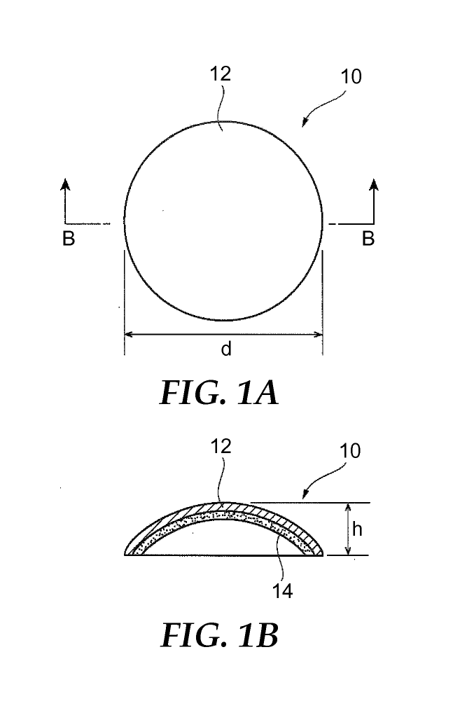

FIG. 1 is a diagram showing the label of the first embodiment schematically according to the present invention, (A) is a top view, and (B) is a cross-sectional view along the B-B line of (A). In this embodiment, the entire label 10 is made up of the convex part. The label 10 makes an approximate ball crown shape, e.g., a spherical cap, and more specifically, forms a convex shape (with reference to the plane of the surface to which the label is to be adhered) at nearly no load with no required force added. In this embodiment, the crown is a spherical cap. In other embodiments, the convex part may be other shape not having a spherical, uniform circular curvature of radius. Label 10 is equipped with an adhesion layer 14 having an adhesive agent inside the base of convex part such as a pressure-sensitive adhesive, and a base 12 made from a sheet-like material (containing film).

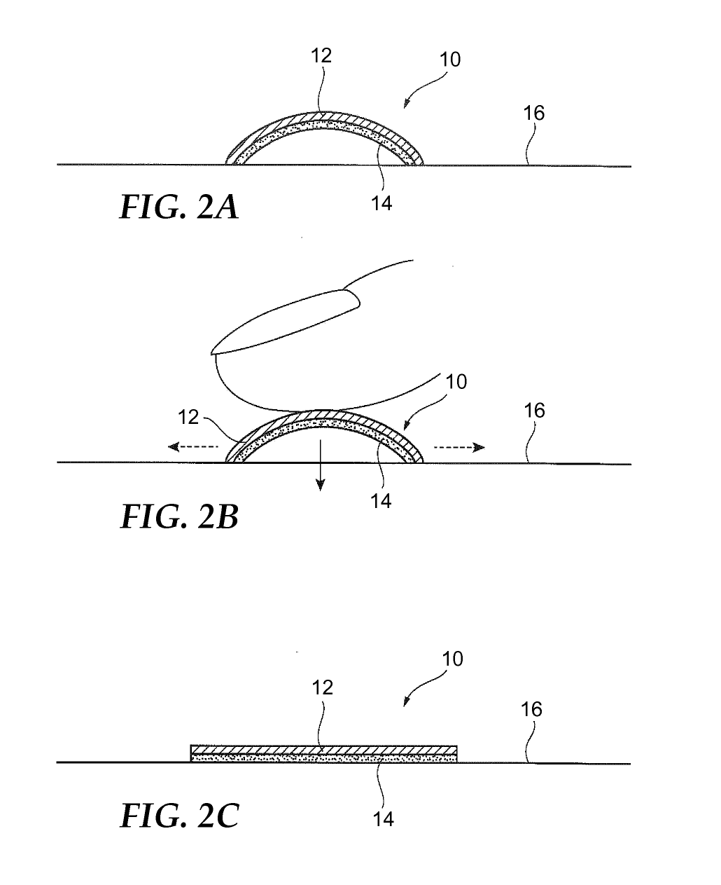

The usage of this label 10 is shown in FIG. 2 as follows. In other words, the adhesion layer 14 is placed with a label facing the label receiving surface 16 ((A) of FIG. 2) on the label receiving surface 16 such as a page, and the convex part of label 10 is subsequently pressed with a finger ((B) of FIG. 2). Thereby, the label 10 transforms at least a portion of the convex part as shown in (C) of FIG. 2, and the label is stuck on the label receiving surface 16, and a layer 14 inside the base of convex part touches the label receiving surface.

Note that, as shown in (C) of FIG. 2, after the convex part of the label is flattened, it is preferable that the label not exhibit a sufficient tendency to recover its convex shape that the strength of the bond of adhesion layer 14 to surface 16 is overcome.

Embodiments of the invention can be made in repositionable form if a repositionable adhesive is selected for adhesive layer 14, and if convex part 12 will substantially recover a convex configuration upon removal of the label from a first position, e.g., by prying the edge up from the surface.

The materials for base 12 are not particularly limited, as long as the material can remain almost flat, preferably maintaining the desired configuration when at a room temperature without continuing pressure applied to it, and the convex part, namely a spherical crown, can be transformed easily by applying the required force, preferably by pushing it lightly with a finger. Further, for example, non-extended polypropylene film, non-extended polyethylene film, polyurethane film, acrylic film, thermoplastic polyester film, and paper are given as base materials.

In addition, the materials for the adhesion layer 14 are also not limited, however when the base 12 is formed from elastic material, it is preferable for the adhesive power of the adhesion layer 14 to be bigger than the restoring force of the base 12 with respect to the label receiving surface 16, because the restoring force used to restore the state of FIG. 1 (A) to its original condition is generated in label 10 and the required force activated in label 10 is removed.

The materials of the adhesion layer 14 should be an adhesive agent and can use pressure-sensitive adhesive with adequate adhesive strength depending on its use. For example, silicon-based pressure-sensitive adhesive, synthetic rubberized pressure-sensitive adhesive, natural rubberized pressure-sensitive adhesive and urethane-based pressure-sensitive adhesive can be used as the pressure-sensitive adhesive. In addition, either permanent adhesion type pressure-sensitive adhesive, or a removable pressure-sensitive adhesive can also be used.

For example, illustrative examples of suitable adhesives include ARON™ Adhesive HV-C9500 from Taogosei Co., Ltd., ARON™ Adhesive HV-C7559 from Taogosei Co., Ltd., FINETAC™ Adhesive CT-5030 from by DC Corporation, Adhesive BPW6112 from Toyochem Co. Ltd., and Adhesive BPW6116 from Toyochem Co. Ltd. For example, SD4580PSA and SD4587LPSA from Dow Corning Toray Co. Ltd., are specific illustrative examples of silicon-based pressure-sensitive adhesive suitable for use herein.

The thickness of the adhesive layer 14 is not particularly limited, typically preferably being from about 5 μm to about 40 μm.

As a method for transforming adhesive layer 14 on one side of the base 12, for example, comma coating, gravure coating, curtain coating, spray coating, inkjet coating, die coating and hot-melt coating can be used. In addition, the adhesive layer 14 dissolves in solvent and water or can be formed by applying a pressure-sensitive adhesive which has been dissolved with heat and dispersed pressure-sensitive adhesive by the above-mentioned method. Moreover, the pressure-sensitive adhesive can be formed by bridging or polymerization by electron beam, ultraviolet rays or heat, after applying precursor in which it becomes a raw material for pressure-sensitive adhesive by the above-mentioned method.

Various fabrication methods can be used as for the forming method of the convex part in base 12. For example, when thermoplastic resin is used as the base material 12, a molding method is given wherein the base material 12 heated to a temperature capable of heat transformation is ran between a roll with a convex part on the surface and a roll with the corresponding concave part, and cooled to a room temperature after being press molded.

Then, the adhesive layer 14 may be formed after forming the convex part in the base 12, and the convex part may be formed after forming the adhesive layer 14 on one side of the base 12.

In addition, suitable steps to ensure effective adhesion of adhesive layer 14 to base 12 may be taken, e.g., prime treatments, preparation of the surface of base 12, etc. It is typically preferred that adhesive layer 14 adhere more strongly to base 12 than it does to surface 16.

As shown in (B) of FIG. 1, the whole label is a convex part, and is different from cases where the adhesion layer 14 is formed on almost the entire back side of the label. A convex part is formed in part of the label as described later, and when forming the adhesion layer 14 only on the inside of the convex part, or when it is desired to form the adhesion layer 14 only on the predetermined part of the label, techniques such as screen-printing or ink-jet printing for example may be used to pattern coat the adhesive.

Furthermore, the diameter d of the circumference of label 10, in other words, the circle diameter with a flat form of the convex part is not particularly limited; however it is typically preferred to be less than about 15 mm or even less than about 10 mm. If it is more than 15 mm, a convex part is formed even if one place of the convex part is pushed once by the finger, and makes it difficult to flatten and paste the entire adhesive layer 14 to the label receiving surface 16. Note that, the circle diameter of the convex part should be more than 2 mm, and preferably more than about 3 mm. If the convex part is too small, effective bonding of the label to surface 16 by hand may be difficult. If the size of the label 10 itself is less than 3 mm, it becomes difficult to hold the label 10 with the fingers. However, in cases where the label 10 will be grasped with a tweezers or the like, the diameter d may be less than about 3 mm, in cases where the finger is used to flatten the entire label 10, the diameter d may be more than about 15 mm.

Moreover, in the above-mentioned usage, the height of the label 10, in other words, the height of the convex part, is preferably about 0.5 mm to about 2.0 mm. If the height (h) is less than about 0.5 mm, the adhesive layer 14 touches the label receiving surface 16 when the label 10 is placed on the side with adhesive layer 16, and the label 10 may not be able to be moved if the position where the label is placed is inappropriate.

On the other hand, the label 10 becomes difficult to stick on the label receiving surface 16 without flattening the entire base 12 of the convex part and it becomes difficult to stick the adhesive layer 14 to the side with the adhesive layer 16 since pressure must be applied with the finger if the height is more than about 2.0 mm. Note that, the above mentioned size fluctuates by various parameter such as the diameter d of the label 10, height h, thickness and material properties of the base 12, or the thickness and material properties of the adhesive layer 14, and are not particularly limited.

The basic usage of label 10 for such a configuration is described above, but there may be cases where the position of the label 10 is stuck may not be the desired position. In such cases, the label 10 slides in all directions over the label receiving surface 16 since the entire surface of layer 14 is not in contact with the label receiving surface 16 when the forces in all directions are added to the label 10 by the finger tips. Also, if the label 10 is moved at the desired position, the label 10 is stuck on the label receiving surface at that position when the convex part of the label 10 is pushed with the same finger. According to this, adjusting the pasting position of label 10 is easier. In addition, mistake in pasting can be resolved. When decorating with the label 10, a high quality decoration can be obtained using the label because the label 10 can be pasted more accurately in a fixed position. Therefore, the label 10 according to the present invention becomes effective even for the purpose of a so-called decoration seal on a nail or cell phone, and not only for the purpose of marking an important point such as a notebook or a textbook. In addition, it can be used in educational materials in which a colored label is stuck at a fixed position of a picture book or a drawing or a game such as a puzzle where a stick decorated label piece are stuck on a fixed position.

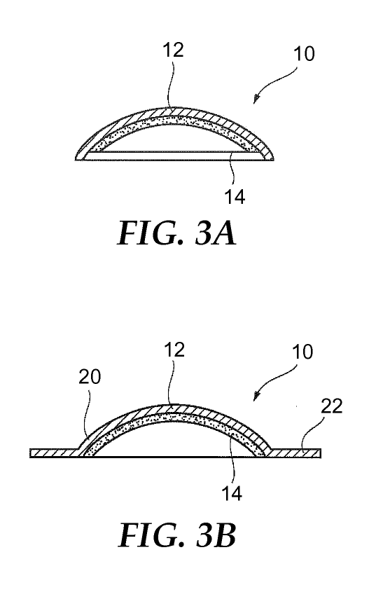

Note that, it appears that the circumference of adhesive layer 14 is somewhat thick, however this is because FIG. 1 and FIG. 2 are exaggerated, and a problem doesn't occur in the slide of label 10 because the actual thickness of the adhesive layer 14 is extremely thin. In cases where the label receiving surface 16 are strongly adhered between the adhesive of the adhesion layer 14 or in cases where it is desired to not to feel a slight catching sensation when sliding the label, the edge of adhesive layer 14 should be located only inside rather than the edge of the convex part, i.e., recessed therefrrom, so that the circumferential edge of the adhesive layer 14 does not extend to the circumference of the base 12. Such an embodiment is shown in (A) of FIG. 3.

The following is a detailed description with regards to the ideal embodiment of the present invention. The invention is, however, not limited to the embodiment.

For example, the label 10 is approximately a ball crown shape according to the above-mentioned embodiment, however, a convex part is formed only at the middle of the label 10 as shown in (B) of FIG. 3, and the edge (fringe) 22 may be a form attached at the outer circumference. In this case, the adhesive layer 14 is not formed at the bottom of the edge 22.

In addition, the convex part does not need to be in an approximate ball crown shape, when no force is exerted by the finger, in other words, it should maintain convexity when there is nearly no load placed on it, and bend when the required force is added, and label 10 which is in contact with the label receiving surface of adhesive layer 14 should be pasted on the label receiving surface. Preferably, the label may be in any shape as long as it lays flat when the required force is added, and at least one portion, preferably the whole label can be transformed into a flat form.

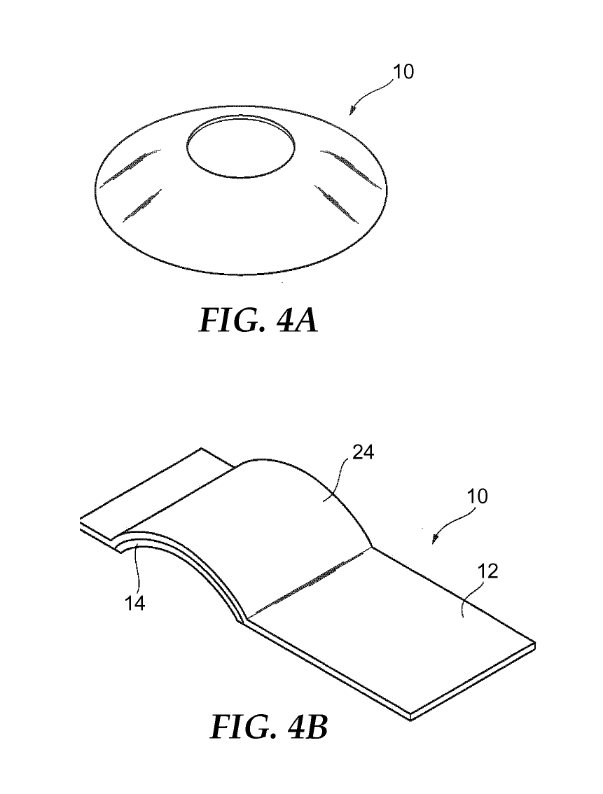

The flat form of the convex part can take various forms such as circle, oval, rectangle, polygon, or an undetermined form. For example, a section in a part of the oval base 12 shown in (B) of FIG. 4, may be a shape with a bend part 24 in the shape of an arc or the center of the convex part may be a shape with a hole, like a spherical ring.

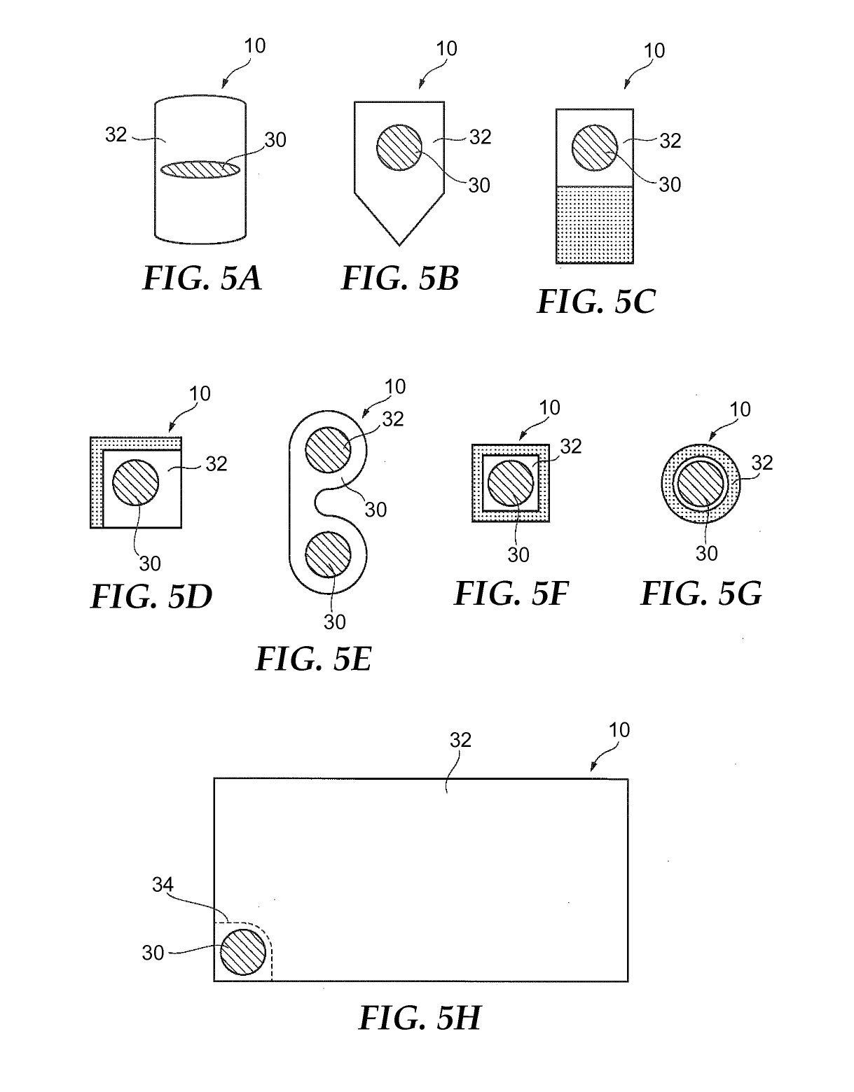

Furthermore, various forms with the convex part with layers of adhesive material constituting a part of base 32 as shown in (A)˜(H) of FIG. 5 and various patterns of label 10 are also within the scope of the present invention. Note that, a form that has a single convex part in one label has mainly been described, however the form may have more than one convex part in one label as shown in (E) of FIG. 5.

Note that, the label 10 of (H) of FIG. 5 is provided with a convex part 30 with an adhesive layer in the corner of the comparatively big tag (base) 32. In this configuration, for example, the tag 32 may be a sheet having a degree of transparency so that the pattern or character below the label receiving surface can be distinguished. Note that, as shown in the same figure, the perforation 34 in the circumference of convex part 30 may be provided. In this configuration, after pasting the tag 32 on the label receiving surface, the other part of the tag 32 can be detached, leaving the convex part 30 on the label receiving surface. Also, the tag 32 can be returned exactly to the original position marking the convex part 30 which has been left. This is effective, for example, when only the data is desired to be copied after doing various writings on tag 32 which is stuck in the data, or when wanting to return the tag 32 exactly into the original position after copying.

### REFERENCE NUMERALS KEY

10 label
14 adhesive layer
16 label receiving surface
20 spherical crown part
22 brim
24 transformation part
30 convex part
32 base
34 perforation

1-6. (canceled)

7. A label for application to a receiving surface, the label comprising a sheet having a portion configured to be in convex configuration defining a corresponding concave portion on the opposite side of the sheet and having an adhesive on at least a portion of the concave portion, wherein the sheet is capable of deforming under application of finger pressure to reconfigure the sheet so as to reduce the convex portion such that the adhesive will contact a receiving surface to which the label is being applied.

8. The label according to claim 1 wherein, the adhesive layer is formed only inside rather than the edge of the convex part.

9. The label according to claim 1 wherein, the convex portion is a spherical crown shape.

10. The label according to claim 1 having a single concave portion.
